(19) United States
(12) Patent Application Publication
(10) Pub. No.: US 2004/0140135 A1
(43) Pub. Date: Jul. 22, 2004

(54) Automatic scale for bulk products

(75) Inventor: Agustin Dauder Guardiola, Barcelona (ES)

Correspondence Address: LACKENBACH SIEGEL, ONE CHASE ROAD, SCARSDALE, NY, 10583, US

(73) Assignee: Talleres Daumar, S.A., Barcelona (ES)

(21) Appl. No.: 10/624,395

(22) Filed: Jul. 22, 2003

(30) Foreign Application Priority Data
Jul. 22, 2002 (ES) 200201828

(51) Int. Cl. G01G 13/02

(52) U.S. Cl. 177/119

(57) ABSTRACT

Automatic scale for bulk products with a feeder mechanism composed of two sets of turning transverse eccentric rollers, with both sets having parallel eccentrics, which are smooth in one set and notched in the other set. The transfer mechanisms have pairs of discs with parallel transverse shafts, with the outside ones having a pin meshed in a fixed toothed wheel, while the central shafts are mounted ungeared. The linear transport mechanisms have rods for supporting the containers with pairs of sliding mechanisms, which are separated by elastic mechanisms and have control mechanisms for varying their distance apart. The weigh station has pairs of parallel, longitudinal endless belts.

### FIELD OF INVENTION

The subject of this Invention Patent is an automatic scale for a wide variety of bulk products, particularly food products of any type or category, and products or objects in general of various sizes, which must subsequently be packed with a total weight or in a predetermined amount and also with predetermined tolerances.

### BACKGROUND OF THE INVENTION

Scales for different products already exist, which transport the products from an entry point in the means and discharge them into containers that are weighed, with an electronic computerized unit that calculates the possible combinations of the weights of the products and selects the combination that has a total weight that is closest to the one sought, ordering the discharge of the product onto a conveyor belt after it leaves the scale. This strategy of selecting products is known as “batch weighing.”

The method of transporting the containers consists of two parallel chains, supported by several toothed wheels at the ends, with a series of supporting frames between the two chains that have short pins on the inside, aligned on the transverse, and from which the containers hang. Both chains have guides that re-direct them downwards in a U-shaped route over the weighing unit, with the containers being temporarily released from the chains when they detach from their pair of short pins, and being picked up again by another pair of short pins.

The scale described above is found in European patent No. 81900325, belonging to the Japanese company, Kabushiki Kaisha Ishida Koki.

For the scale to be properly constructed, its speed of movement must be relatively slow in order to assure a certain degree of precision in weighing, and it may even be necessary to halt the chains occasionally, so that the containers will be stable, in order to eliminate or reduce as much as possible the force of inertia resulting from their own movement. This force would alter the values of the real weight, in addition to producing harmful effects as a result of the oscillation of the containers.

The Assignee of the present invention is the holder of Spanish Patent No. 2111477 (Application No. 9501879, filed Sep. 29, 1995), the subject of which is a number of improvements to automatic weighing machines for diverse products, particularly food products, which are characterized, in its claim No. 1, by:

Filiform stretched elastic means, arranged longitudinally and in parallel form and introduced into the feeder devices for the products at the entrance to the machine;

Means for transferring the products from the feeding means at the entrance of the machine into the containers, which have means for raising the products by ranks or transverse rows and means for temporarily holding the rows, with both means being synchronized and controlled by the programming unit;

Means for guiding the lines of the linear transport means, which bring their corresponding containers to meet the means that transfer the products;

Stabilization stations for the containers of the respective lines before their weighing;

Means for guiding the descent of the containers of each line and for resting them on the stabilization station and then on the corresponding weigh station;

Segments in the guiding means for the containers of each line, which can be controlled by the programming unit and can be temporarily diverted independently of the guides, in order to selectively dump the products contained in the containers at the corresponding discharge stations;

Segments of the guiding means for the containers of each line that return the inverted containers to their operating position;

Support means for each container, consisting of means for supporting and temporarily holding it, in cooperation with the corresponding means in the container itself, and means for connecting to a transverse pin joined to the linear transport means, which also have their own means of support connected to a lateral arm that has rotating or sliding support means on the guide means of the linear transport means;

Filiform, flexible means for pulling the containers, operating during their passage through the corresponding stabilization and weigh stations, with these filiform means being connected at their ends, respectively, to the containers and their corresponding support means;

Means for conducting the products that are already weighed and discharged from the containers onto the transverse transport means;

Selective action in both directions of the transverse transport means for products already weighed and regulation of those means by the programming unit;

In accordance with its second claim, those improvements are characterized by the inclusion, on an optional basis, of sheet-like means that, in their operating position, may be placed over the means for feeding the products at the entrance to the machine, can be controlled as to the area of the products to be covered, and can be hidden when not in operating position, with means for moving and guiding them as well.

Automatic weighing machines possessing the improvements that are the subject of Spanish Patent No. 2111477 have yielded satisfactory results. The applicant entity, based on its experience in this technological field and the use of the weighing machine according to the aforementioned patent, has conceived and developed the automatic scale that is the subject of this invention, which is a scale that has certain characteristics that make it very appropriate for use in cases requiring gentle feeding of the products, guarantees constant velocity of the products in the different stages of the scale and precision in weighing, and has a relatively small footprint.

### SUMMARY OF THE INVENTION

The automatic scale for bulk products that is the subject of the invention is the kind that includes a supporting framework for the parts of the machine, means for activating those parts, means for feeding the products into the scale that transport them through longitudinal parallel channels and discharge them into containers arranged in corresponding tracks or lines of linear transport means, located along a cyclical closed circuit and between parallel longitudinal vertical planes.

The transport means are provided with as many lines as there are channels in the feeding means, the channels and lines of which are placed on the same corresponding planes to enable transfer of the products, so that empty containers will continue to be filled. All of the containers circulate through the respective weigh stations, full or empty, and through the corresponding selective discharge stations for products already weighed, onto the transverse transport means.

This type of scale also includes: a programming unit that records the tare of each container and the real weight of the product or products that it collects; means for connecting that unit and the corresponding parts of the machine; means for guiding the linear transport means and the containers; and means for directing, controlling and ensuring the safety of the scale.

The automatic bulk product scale is characterized by the following distinctive features:

The means for feeding the products at the entrance of the scale include, in each longitudinal channel and on a support, an initial set of transverse eccentric rollers, which are composed of transverse rods provided with a series of circular eccentrics, parallel to each other and perpendicular to the corresponding rods, and a second set of eccentric transverse rollers, composed of transverse rods provided with a series of circular eccentrics, parallel to each other, perpendicular to the corresponding rod, and provided with various notches in the area closest to the transverse rods; and the eccentrics of each rod interleave with those of the juxtaposed rods, with these rods being rotated by corresponding reduction motors with respective means of transmission.

The feeders are connected to the means for transferring the corresponding products, which, for their part, discharge the products into the containers; and these transfer means are composed of as many pairs of parallel disks as there are rails or lines in the linear transport means. Between each pair of disks, on their edges, are transverse revolving rods, which project beyond one disk and have an attached pinion that meshes with its respective vertical fixed toothed wheel, with the disks of each pair being activated by the corresponding reduction motors and means of transmission of the feeder. Between each pair of disks, near its central geometric axis, idler shafts are mounted parallel to the transverse rods; and between each pair of rods, one transverse and the other an idler, is mounted a flexible endless belt.

The linear transport means— with an initial vertical segment for lowering the containers, a second, lower, horizontal segment, and third vertical segment for raising the containers, and a fourth, upper, horizontal segment—have a series of transverse rods for supporting the containers, mounted between linear pulling means arranged on the guides and moved by various activation and transmission means. Each rod includes pairs of sliding means for securing each container, between which there is an elastic means that holds them apart and, perpendicular to the rod, there are various activation means for releasing and grabbing the container, corresponding to a supporting pin, when it is in the weigh station.

The weigh station has means for receiving the containers, with pairs of parallel, longitudinal endless belts, upon which the respective containers will rest for their weighing and transporting out of the station. The containers are brought to the weigh station by the line transport means, released from the supporting pins for weighing, and then picked up by them again. Each pair of endless belts is moved by its respective activating means with its means of transmission.

The automatic bulk product scale, in accordance with the invention defined in the claim, provides among others the following advantages that are solely and exclusively its own:

Very gentle transport of products from the entrance of the scale, in a wave-like manner, with a system of eccentric rollers that only turn upon themselves and do not move in a linear direction.

Precision in the weighing of each container because it is completely free during the weighing process, because it is transported by a pair of endless belts and it makes no physical contact with the means of linear transport.

A servo-controlled system guarantees that, for each pair of endless belts, the linear speed of the container before being released will be maintained, and that it will be picked up at that speed after being weighed.

The scale is basically vertical in form, which significantly reduces its footprint, facilitating its installation in packing plants.

### BRIEF DESCRIPTION OF THE DRAWINGS

FIG. 1 shows a right-side elevation of an automatic scale in accordance with the invention.

FIG. 2 shows another, larger elevation of the left side of the scale, showing some details of the linear transport means.

FIG. 3 is a left-side elevation of some of the means for feeding the products at the entry to the scale.

FIG. 4 is a floor plan of the means in FIG. 3.

FIG. 5 shows a detail of a floor plan of the feeder means in FIG. 4.

FIG. 6 is a view through (1) of the detail of FIG. 5.

FIG. 7 shows a front elevation of the means for transferring the products to be weighed.

FIG. 8 shows a left-side elevation of the transfer means in FIG. 7.

FIG. 9 is a right-side elevation of the transfer means in FIG. 7.

FIG. 10 shows, in perspective, transfer means for the products to be weighed, with the left side being shown in front.

FIG. 11 is a partially cut-away front elevation of some of the linear transport means.

FIG. 12 is the view of the container from its right side.

FIG. 13 is a rear elevation of the container.

FIG. 14 is a partial elevation of a supporting pin for the containers, showing only a part of the pin belonging to a line or channel.

FIG. 15 is a floor plan of a weigh station.

### DESCRIPTION OF THE MODEL ACCORDING TO THE INVENTION

In accordance with the drawings, the automatic scale, based on an embodiment of the invention, is of the type (figures regarding its generic layout are 1, 2, 4, 11, 13 and 15) composed of a supporting framework (with legs or means of support and regulation, and if necessary, means for anchoring it to the floor), such as in general (“in general” in this document refers to a generic layout, rather than a specific construction) the supporting framework (A), for supporting the various components of the scale.

In addition, it includes means for activating those components; variable core feeder means, such as, in general, the means for feeding (B) products into the scale and carrying them through longitudinal channels, such as, in general, channel (C), which discharge them into containers, such as, in general, container (D), arranged in corresponding tracks or lines, such as, in general, line (E), of linear transport means, such as, in general, means (F), with the lines being located in a cyclical closed circuit between longitudinal parallel vertical planes.

The transport means (F) has as many lines (E) as there are channels (C) in the feeder means (B), the channels and lines of which are placed on the same plane for the transfer of the products to the empty containers through the respective transfer means, with the empty containers continuing to receive the products.

All of the containers circulate through their respective weigh stations, such as, in general, (G), full or empty (in the latter case, for the purpose of obtaining the tare) and through corresponding selective stations for products already weighed to be discharged onto the appropriate transverse transport means, such as, in general, means (H).

The number of channels and, therefore, transport means, lines of containers and weigh stations, must be determined on the basis of the use to which the scale is applied, although in principle, it is estimated that three of them would be suitable or appropriate for normal uses. The number of selective product discharge stations and of transverse transport means is based on the parameters of the scale and its possible uses.

This type of scale also includes: a programming unit that records the tare of each container and the real weight of the product or products that it is collecting; means for connecting that unit and the corresponding weighing components; means for guiding the linear transport means and the containers; and means for direction, control and safety of the scale.

The scale, according to this embodiment of the present invention, has, in this example, three channels in the feeder means as well as three transfer means, three lines in the linear transport means and three weigh stations; and there are four selective discharge stations as well as four transverse transport means.

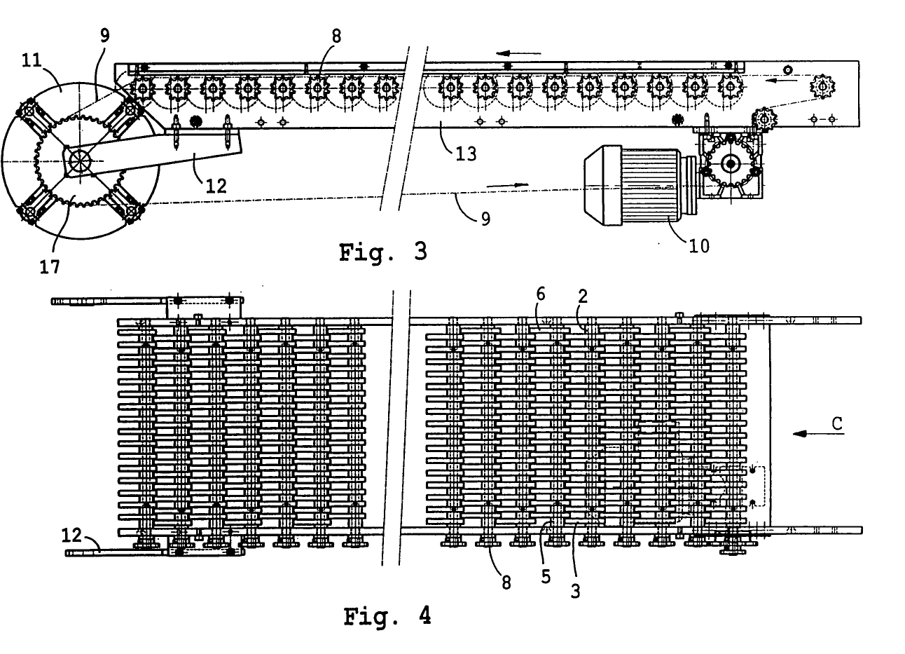

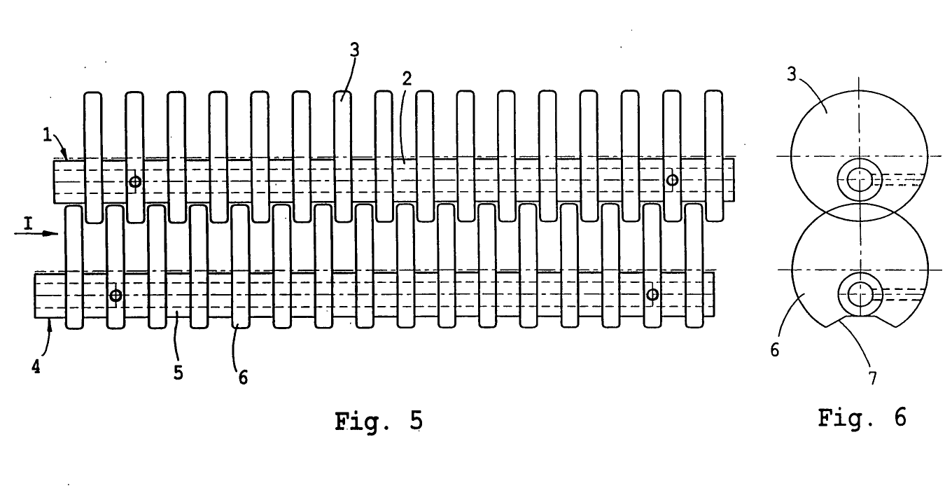

The feeder means of the scale (FIGS. 3 to 6) comprises, in each longitudinal channel, a series of transverse eccentric rollers, such as roller (1), composed of a transverse rod (2) provided with a series of circular eccentrics (3) fixed on the rod (2), parallel to each other and perpendicular to the rod; and another series of transverse eccentric rollers, such as roller (4), composed of a transverse rod (5), with a succession of circular eccentrics (6) attached to the rod (5), parallel to each other and perpendicular to the rod, with the eccentrics having individual notches (7) in the zone closest to the transverse rod (5). The eccentrics of each rod are put in between the eccentrics of the juxtaposed rods, as shown in FIGS. 4 and 5 (in the latter, as a detail of two successive rods).

The rods protrude out of their framework (13) at one of their ends, to which are attached pinions (8) that mesh with a chain (9), which is activated in this example by a reduction motor (10) with its corresponding transmission means. In this way, the transverse rods turn upon themselves without linear movement or change, with a gentle wavelike action, from the time they enter the feeding means until they leave it and make their delivery to the transport means.

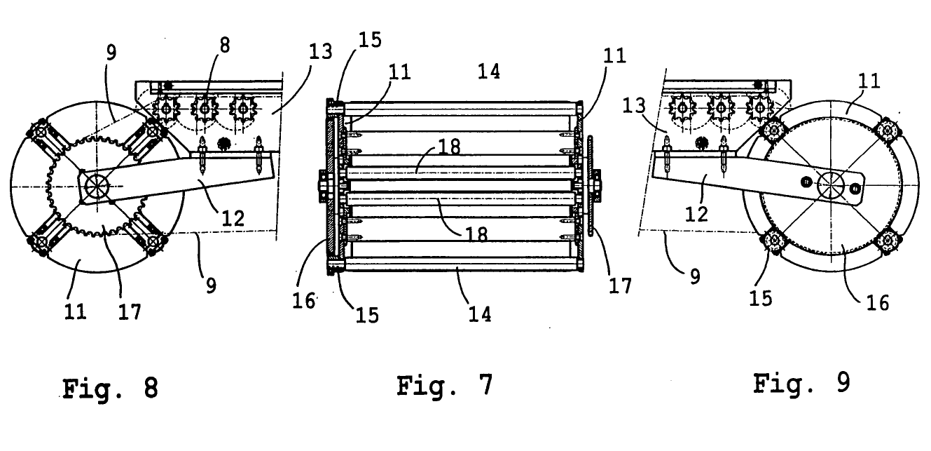

The feeding means are linked with transfer means (FIGS. 7 to 10) composed of as many pairs of parallel disks, such as disks (11), as there are tracks or lines in the linear transport means, which are three, in this case. The central rod of each pair of disks, which is perpendicular thereto, is mounted on arm-like supports (12) and joined to the support framework (13) (FIGS. 3, 8 and 9) of the feeder means.

Between each pair of disks (11) and its outside edge, transverse rods (14), numbering four in the model, are mounted and held in rotation, with one of their ends protruding beyond the corresponding disk and having an attached pinion (15); the four rods mesh with a fixed, vertical toothed wheel (16). The disks in each pair are activated by the same chain (9) as that of the feeder means, by means of the toothed wheel (17) and the reduction motor (10) with its transmission means.

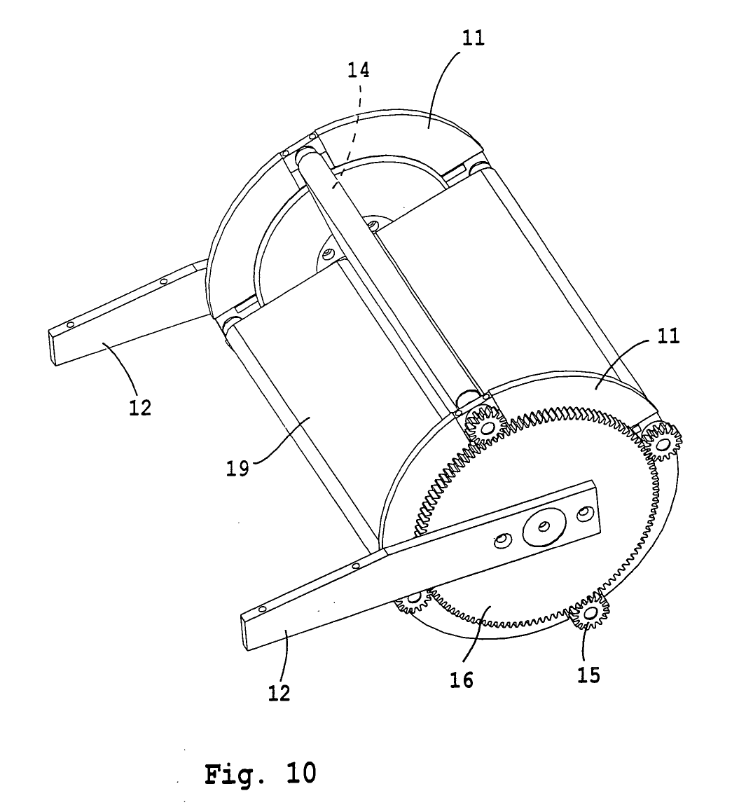

In addition, between each pair of disks (11) and next to its central geometric axis, idler shafts (18) are mounted (FIG. 7) in a number equal to the peripheral rods (14), of which there are four in this example, lined up radially with the rods (14). Between each pair of rods, one transverse peripheral (14) and the other idle (18), is a flexible endless belt (19) (FIG. 10). When the pair of disks (11) turns with the rods, four peripheral (14) and four idle (18), the four pinions (15) of the former turn around the fixed wheel (16), causing the respective belts (19) to move. In this way, the aforementioned transfer means receive the products gently on the corresponding belt and deliver them gently to the containers.

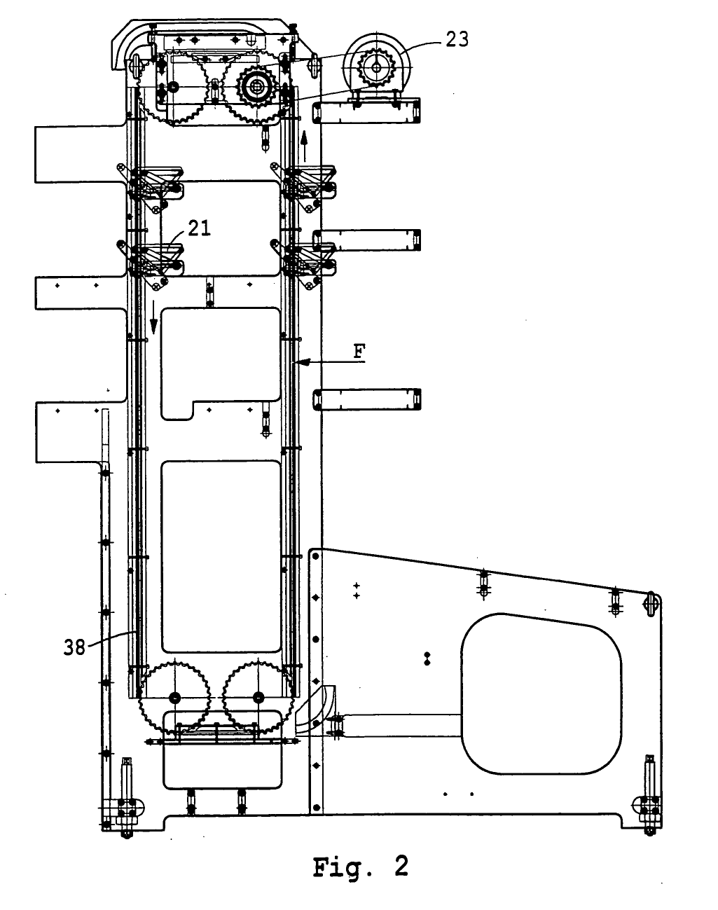

The linear transport means (F) (FIG. 2) include a first vertical segment for lowering the containers, a second horizontal lower segment, a third vertical segment for raising the containers, and a fourth horizontal upper segment. The two chains of the linear transport means are activated by an electric motor or a reduction motor (23) with the corresponding transmission means. Each of the aforementioned chains is guided by four toothed wheels, with means for regulating their tension, with one of the tooth wheels being activated by the reduction motor.

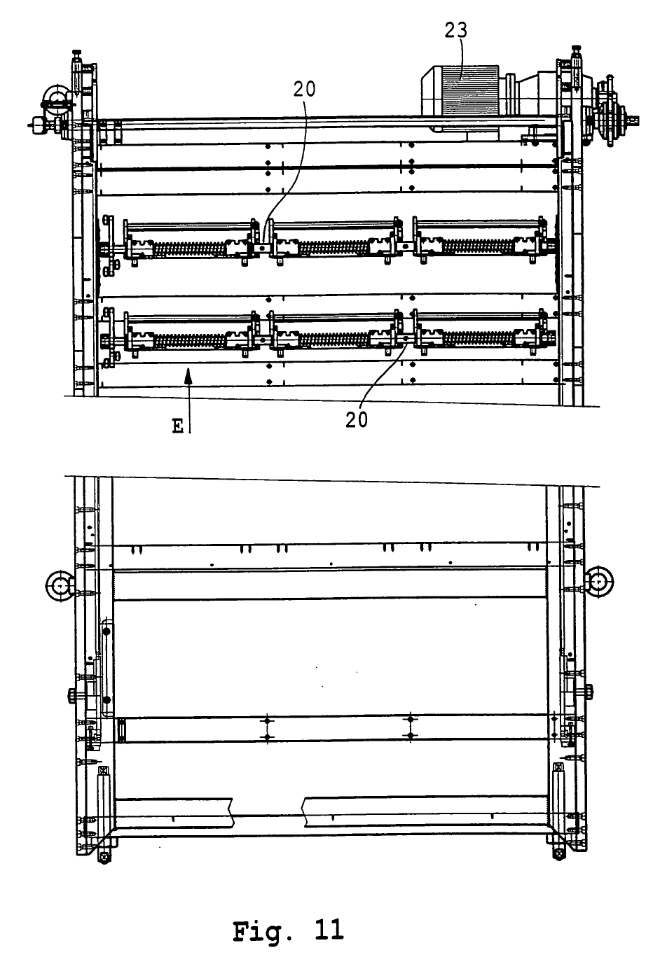

These linear transport means have a series of rods (20) for supporting the containers (21) (FIGS. 11, 12, 13 and 14). These rods are mounted between the two parallel chains of the linear transport means and are parallel to each other, and vary in number according to the features of the scale. Each rod has, at one of its ends, a perpendicular arm that has (in this case) three bearings (22) connected to the means for guiding and moving the rods (20) and containers (21), to hold the containers in a position suitable for keeping the product or products contained in them, as well as to maintain them in position during the changes in direction during the trip along the linear transport means until their discharge. In addition, the containers are given a slight turn at the time of their loading, which helps to achieve a smooth transfer of the products to the corresponding containers that are to be loaded.

Each rod (20) includes a pair of sliding means (24) that can be moved around the rod and have a spring there between to maintain the distance between each pair of sliding means. Each of the sliding means (24) has a projection (26) that is perpendicular to the rod and whose function is to move the sliding means (24) in one direction or another, first to grab and then to release the corresponding containers without changing the distance between each pair of means (24). The phase of releasing the containers occurs, precisely, at the weigh station, as will be described below.

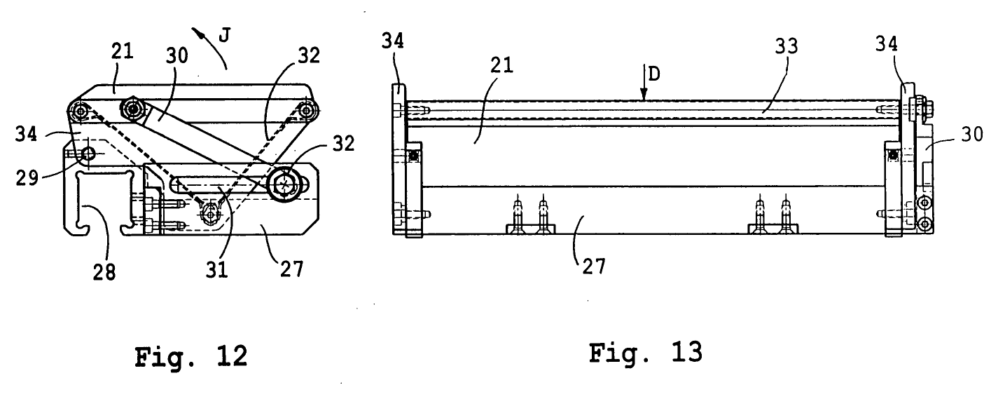

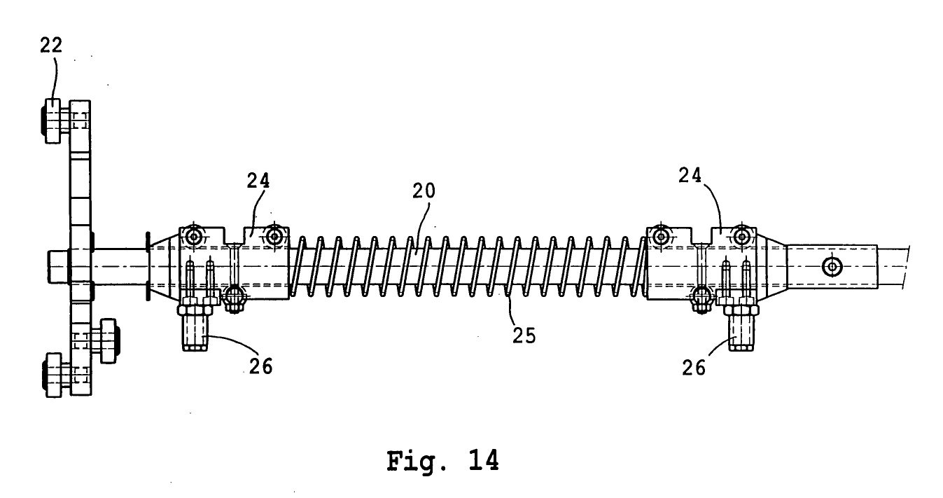

Each container (21) (FIGS. 12 and 13) is mounted on a framework (27) that has two arms (28) in the form of an inverted “C,” with its open side down, located at each end of the framework. The two arms of the frame of the container are used to connect to the corresponding part of the support pin (20) of the containers.

As can be seen in FIG. 12, the container is joined to the framework (27) by the rod (29) and by another that is located symmetrically on the opposite end of the framework. On the right side of the container (21) there is a lever (30) joined to the upper part of the container and to a short rod, which goes through a slot (31) of the framework (27) and has a bearing (32) on the outside.

When the bearing is activated, toward the left according to FIG. 12, it is moved in the same direction, following the course of the slot (31), and simultaneously turning the container in the direction of the arrow (J). This results in the overturning of the container and the dumping of the products contained in it. Following this, the container is returned to its working position. The two movements of the container that have been described are controlled by means included in the scale for that purpose. In addition, the container in this example has an interior constructed of a flexible sheet (32), held up between three longitudinal bars such as bar (33), attached to two vertical plates (34), and located, respectively, on each of the two sides of the container. This results in the gentle transfer of the products to the containers and the correct fit of the products in the containers during their entire passage through the scale.

On the basis of the foregoing, it can be seen that the containers are articulated by a system of levers that enable all of their movements to be activated by cogs, so that the turning of the containers when they are being emptied is not the result of gravity, but is at all times mechanically controlled. Furthermore, the containers that are to be loaded with products turn slightly, due to the cogs, resulting in a very gentle transfer of the products.

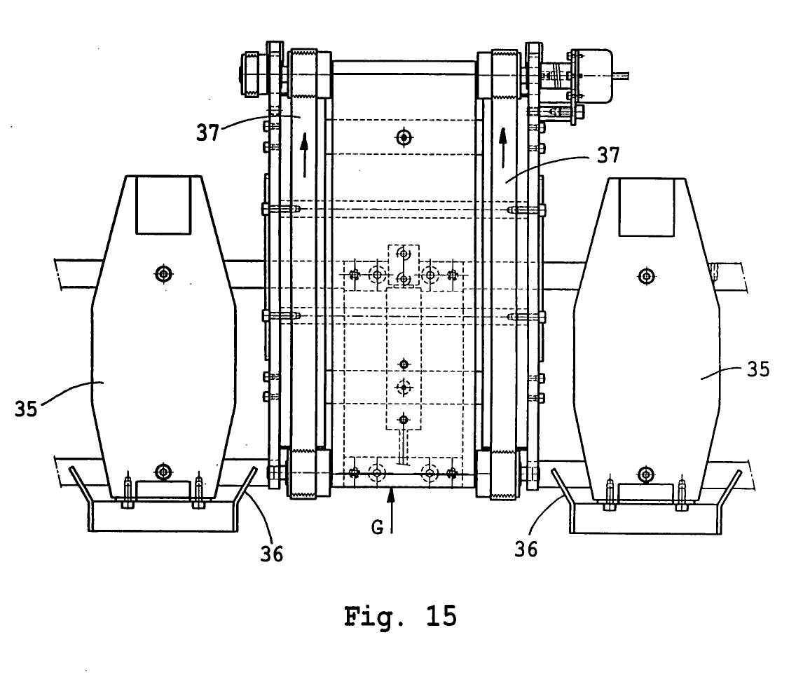

Each weigh station (G) (FIG. 15) is located between two horizontal plates (35), which have guides (36) converging toward the exit from the station. At the beginning of the passage of each container through the weigh station, the guides (36) pull together the pair of projections (26) of the corresponding sliding means (24) of the respective section of the supporting rod (20) of the containers, causing each container to be released from its rod, and to be supported and rest upon a pair of parallel, longitudinal endless belts (37), which are activated by a suitable means. In this way, each container is moved (in the direction and way indicated by the arrows in FIG. 15) by the pair of endless belts, and is weighed at the same time, because the belts are connected to the load cell or to another conventional weighing means.

After the weighing of the container, full or empty, the pair of projections (26) are themselves released from the plates (35) and return, by spring action (25), to the position for holding the container. This stage is performed, in practice, at such a speed that the actions described above are performed in a very short time, with the speed at which the pair of chains (36) of the linear transport means are moved (in FIG. 2, one of the chains may be seen) in the weigh stations being equal to the speed at which the pair of endless belts (37) moves.

The rims or lateral edges of the plates (35) are configured in such a way as to maintain the pair of projections (26) in a position where they are close to each other, thus preventing each corresponding pair of sliding means (24) of each pin (20) from attaching to the respective container (21). At their outside edges, the plates (35) have a configuration that makes it possible to release the pair of projections (26) and, by so doing, separate the pair of sliding means (24), due to the spring (25), attaching the respective container, which then can be moved again by the linear transport means.

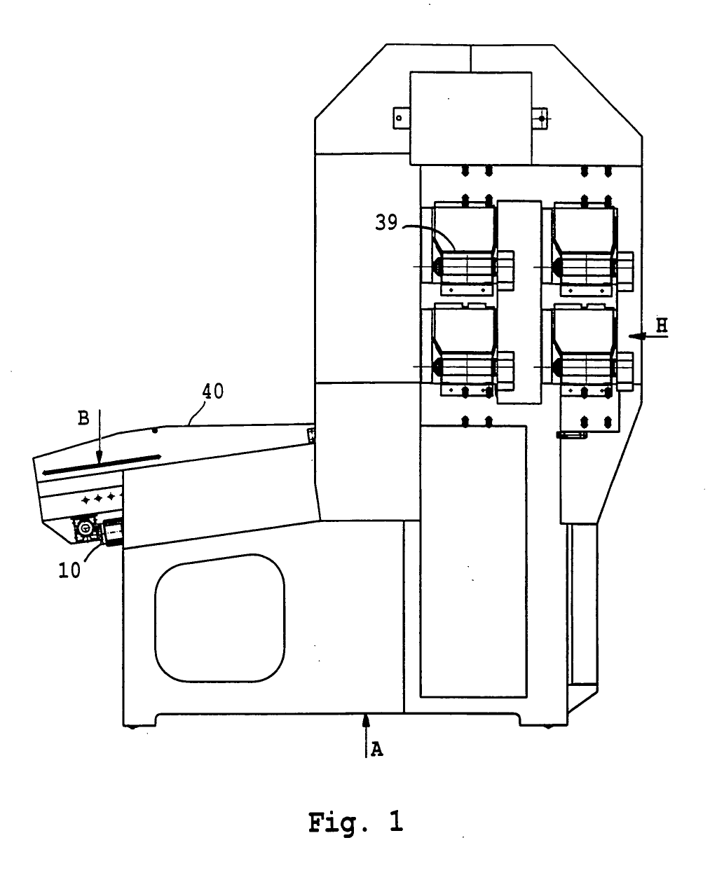

The containers that have been filled with products and the containers that are still empty are passed through the respective weigh stations and are transported to the selected discharge stations, in which they will be overturned, selected on the basis of their individual weight and that will give a total predetermined weight, with a tolerance that is also predetermined. The inversion of the selected containers at that time results in the discharge of the products contained in them onto the transverse transport means (39) (FIG. 1), of which there are four in this example, and which are arranged in parallel pairs, one next to the upper part of the descending path of the containers and the other next to the upper part of the ascending path of the containers. Each transverse transport means basically consists of an endless belt, with an activating means that can move it in one direction or the opposite, some of which are in the form of conventional flexible belts with an upper guide to direct the products that are discharged from the containers.

FIG. 1 shows a cover (40) that covers the feeder means and the products transported by them, with the cover being joined to the framework of the scale in such a way that it can be lifted and the means and/or products can be accessed.

Having thus described a presently preferred embodiment of the present invention, it will be appreciated that the objects of the invention have been achieved, and it will be understood by those skilled in the art that changes in construction and widely differing embodiments and applications of the invention will suggest themselves without departing from the spirit and scope of the present invention. The disclosures and description herein are intended to be illustrative and are not in any sense limiting of the invention.

What is claimed is:

1. An automatic scale for bulk products, of the type that includes a supporting framework for the parts of the machine, means for activating those parts, and means for feeding the products into the scale, which transport them through longitudinal parallel channels and discharge them into containers arranged in corresponding tracks or lines of linear transport means, located along a cyclical closed circuit and between parallel longitudinal vertical planes. The transport means are provided with as many lines as there are channels in the feeding means, the channels and lines of which are placed on the same corresponding planes to enable the transfer of the products, so that the empty containers will continue to be filled. All of the containers circulate through the respective weigh stations, full or empty, and through the corresponding stations for the selective discharge of products already weighed onto the transverse transport means. This type of scale also includes a programming unit that records the tare of each container and the real weight of the product or products that it is collecting, means for connecting that unit to the corresponding parts of the machine, as well as means for guiding the linear transport means and the containers, and means for directing, controlling and ensuring the safety of the scale. It is characterized by the following distinctive features:

2. The automatic scale of claim 1, wherein the means for feeding the products at the entrance of the scale include, in each longitudinal channel, an initial set of transverse eccentric rollers, which are composed of transverse rods provided with a series of circular eccentrics, parallel to each other and perpendicular to the corresponding rods, and a second set of eccentric transverse rollers, composed of transverse rods provided with a series of circular eccentrics, parallel to each other, perpendicular to the corresponding rod, and provided with various notches in the area closest to the transverse rods. The eccentrics of each rod interleave with those of the juxtaposed rods, with these rods being rotated by corresponding reduction motors with respective transmission means.

3. The automatic scale of claim 1, wherein the feeders are connected to means for transferring the corresponding products, which then discharge the products into the containers; and the transfer means are composed of as many pairs of parallel disks as there are lines in the linear transport means. Between each pair of disks, on their edges, are transverse revolving rods, which project beyond one disk and have a pinion attached that meshes with its respective vertical fixed toothed wheel, with the disks of each pair being activated by the corresponding reduction motors and means of transmission of the feeder. Between each pair of disks, near its central geometric axis, idler shafts are mounted parallel to the transverse rods; and between each pair of rods, one transverse and the other an idler, is mounted a flexible endless belt.

4. The automatic scale of claim 1, wherein the linear transport means—with an initial vertical segment for lowering the containers, a second, lower, horizontal segment, and third vertical segment for raising the containers, and a fourth, upper, horizontal segment—have a series of transverse rods for supporting the containers, mounted between linear pulling means arranged on the guides and moved by various activation and transmission means. Each rod includes pairs of sliding means for securing each container, between which there is an elastic means that holds them apart and, perpendicular to the rod, various activation means for releasing and grabbing the container corresponding to a supporting pin when it is in the weigh station.

5. The automatic scale of claim 1, wherein the weigh station has means for receiving the containers, provided with pairs of parallel, longitudinal endless belts, upon which the respective containers rest for their weighing and transporting out of the station. The containers are brought to the weigh station by the linear transport means, are released from the supporting pins for weighing, and then picked up by them again. Each pair of endless belts is moved by its respective activating means with its transmission means.

6. An automatic bulk product scale comprising:
a product feeding and discharge channel comprising:
a plurality of transverse eccentric rollers that each comprise:
a transverse rod supporting a plurality of eccentrics, each of the eccentrics having a respective notched segment and being mounted on the transverse rod such that the transverse rod is adjacent to the respective notched segment,
whereby the transverse eccentric rollers are adapted to rotate in a wave-like manner and gently transport bulk products in a linear direction through the feeding and discharge channel.

7. The automatic bulk product scale of claim 6, further comprising a product transport means comprising:
a plurality of pairs of supports, each of the pairs of supports being adapted to support a respective flexible belt, and each of the pairs of supports comprising a respective rotatable support adapted to rotate its respective flexible belt,
whereby the product transport means is adapted to receive products from the product feeding and discharge channel gently onto one of the respective flexible belts and subsequently deliver the products gently to one or more product containers.

8. The automatic bulk product scale of claim 6, further comprising an automatic bulk product scale comprising:
a line transport means comprising:
a series of transverse container-supporting means, and means for moving the container-supporting means.

9. The automatic bulk product scale of claim 8, further comprising:
a weigh station wherein containers are brought by the line transport means, released therefrom, weighed, and then returned to the line transport means,
whereby the weighing of each container is not supported by the line transport means during while being weighed.

10. The automatic bulk product scale of claim 9, further comprising a servo-controlled system, wherein the linear speed of the container is maintained in the weigh station, whereby the container is released from the line transport means and returned to the line transport means at substantially the same speed.

11. An automatic bulk product scale comprising:
a product feeding and discharge channel; and
a product transport means comprising:
a plurality of pairs of supports, each of the pairs of supports being adapted to support a respective flexible belt, and each of the pairs of supports comprising a respective rotatable support adapted to rotate its respective flexible belt,
whereby the product transport means is adapted to receive products from the product feeding and discharge channel gently onto one of the respective flexible belts and subsequently deliver the products gently to one or more product containers.

12. The automatic bulk product scale of claim 11, wherein the product feeding and discharge channel comprises:
a plurality of transverse eccentric rollers that each comprise:
a transverse rod supporting a plurality of eccentrics, each of the eccentrics having a respective notched segment and being mounted on the transverse rod such that the transverse rod is adjacent to the respective notched segment,
whereby the transverse eccentric rollers are adapted to rotate in a wave-like manner and gently transport bulk products in a linear direction through the feeding and discharge channel.

13. The automatic bulk product scale of claim 11, further comprising a line transport means comprising:
a linear container transport means comprising:
a series of transverse container-supporting means, and means for moving the container-supporting means.

14. The automatic bulk product scale of claim 13, further comprising:
a weigh station wherein containers are brought by the line transport means, released therefrom, weighed, and then returned to the line transport means,
whereby the weighing of each container is not supported by the line transport means during while being weighed.

15. The automatic bulk product scale of claim 14, further comprising a servo-controlled system, wherein the linear speed of the container is maintained in the weigh station, whereby the container is released from the line transport means and returned to the line transport means at substantially the same speed.
